(19) United States
(12) Patent Application Publication
(10) Pub. No.: US 2004/0224548 A1
(43) Pub. Date: Nov. 11, 2004

(54) ELECTRICAL CONNECTOR WITH SELF-CORRECTING ACTUATION DEVICE

(76) Inventor: Wei Yu, Kunsan (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/688,765

(22) Filed: Oct. 15, 2003

(30) Foreign Application Priority Data
May 7, 2003 (TW) 92208369

(51) Int. Cl. H01R 4/50

(52) U.S. Cl. 439/342

(57) ABSTRACT

An electrical connector (1) for electrically connecting an electronic package with a circuit substrate. The connector includes an insulative base (10), a cover (16), and an actuation device (4) assembled between the cover and the base for actuating the cover to slide along the base. The actuation device includes a cam pole (40), an operation lever (42) extending substantially perpendicularly from one end of the cam pole, and a spring member (3) assembled with the cam pole. When the operation lever is inadvertently positioned midway between the open position and a closed position, the spring member provides a restoring force to the cam pole. Thus, the operation lever can automatically re-position itself to the open position and leads of the CPU can be inserted into the connector without destruction.

### BACKGROUND OF THE INVENTION

1. Field of the Invention

The present invention relates to an electrical connector for electrically connecting an electronic package such as a central processing unit (CPU) with a circuit substrate such as a printed circuit board (PCB), and particularly to an electrical connector with a self-correcting actuation device that can automatically position itself to an open position prior to attachment of the CPU onto the connector.

2. Description of Prior Art

Electrical connectors are widely used in personal computer (PC) systems for electrically connecting electronic packages such as CPUs with circuit substrates such as PCBs. Typical such electrical connectors are known as CPU sockets. A typical CPU socket comprises a base soldered to and electrically connected with a PCB, a cover slidably mounted on the base and having a CPU attached thereon, and an actuation device for actuating the cover to slide along the base.

FIG. 7 shows a conventional CPU socket 9. The socket 9 comprises a base 7, a cover 8, and an actuation device 5 assembled between the base 7 and the cover 8 for actuating the cover 8 to slide along the base 7. A CPU (not shown) has a plurality of leads (not shown) depending from a bottom surface thereof and arranged in a rectangular array. The cover 8 has a plurality of through holes 82 arranged in a rectangular array, corresponding to the leads of the CPU. The base 7 comprises a main body (not labeled), and a head portion 72 extending from one end of the main body. The main body has a plurality of receiving passageways (not shown) arranged in a rectangular array corresponding to the leads of the CPU. Each receiving passageway receives an electrical terminal (not shown) therein. The head portion 72 comprises a receiving slot 54 and a hook 52. An actuation surface 540 is defined in the head portion 72 at the receiving slot 54. The actuation device 5 comprises an operation lever 50 to facilitate manual handling by a user.

In use, the operation lever 50 is set against the actuation surface 540, and the socket 9 is in an open position. The CPU is attached to the socket 9. The leads of the CPU extend through the corresponding through holes 82 of the cover 8 and are received in the corresponding passageways of the base 7. The leads of the CPU do not contact the corresponding electrical terminals. That is, the CPU is attached on the CPU socket 9 with zero insertion force. In particular, the leads of the CPU are prevented from being flexed by sudden force being applied thereto by the electrical terminals. Then, the operation lever 50 is rotated toward the hook 52, and the cover 8 is driven to slide along the base 7. The operation lever 50 is locked under the hook 52, and the socket 9 reaches a closed position. The actuation device 5 thus pushes the leads of the CPU into mechanical and electrical engagement with the electrical terminals.

Prior to attachment of the CPU onto the socket 9, the operation lever 50 may be inadvertently positioned midway between the open position and the closed position. When the CPU is attached to the socket 9, the leads of the CPU are inserted directly into the electrical terminals of the base 7. The leads of the CPU are liable to sustain damage, in which case the electrical engagements between the leads of the CPU and the corresponding electrical terminals may be impaired.

This kind of conventional CPU socket is detailed in “Development of ZIF BGA Socket” (pp16˜18, May 2000, Connector Specifier Journal). Similar kinds of CPU sockets are also disclosed in U.S. Pat. Nos. 6,146,178, 6,280,223, 6,419,514 and 6,530,797.

In view of the above, a new electrical connector that overcomes the above-mentioned disadvantages is desired.

### SUMMARY OF THE INVENTION

Accordingly, an object of the present invention is to provide an electrical connector for electrically connecting an electronic package such as a central processing unit (CPU) with a circuit substrate such as a printed circuit board (PCB), in which the connector has a self-correcting actuation device that can automatically position itself to an open position prior to attachment of the CPU onto the connector.

To achieve the above-mentioned object, an electrical connector in accordance with a preferred embodiment of the present invention is for electrically connecting a CPU with a PCB. The electrical connector comprises an insulative base soldered to and electrically connected with the PCB, a cover slidably mounted on the base 10 and having the CPU attached thereon, and an actuation device assembled between the cover and the base for actuating the cover to slide along the base. The actuation device comprises a cam pole, an operation lever extending substantially perpendicularly from one end of the cam pole, and a spring member assembled with the cam pole. When the operation lever is inadvertently positioned midway between the open position and a closed position, the spring member provides a restoring force to the cam pole. Thus, the operation lever can automatically re-position itself to the open position and leads of the CPU can be inserted into the connector without destruction.

Other objects, advantages and novel features of the invention will became more apparent from the following detailed description when taken in conjunction with the accompanying drawings, in which:

### BRIEF DESCRIPTION OF THE DRAWINGS

FIG. 1 is an exploded, isometric view of an electrical connector in accordance with the preferred embodiment of the present invention;

FIG. 2 is an enlarged view of parts of an actuation device and a head portion of a base of the connector of FIG. 1;

FIG. 3 is similar to FIG. 2, but viewed from another aspect;

FIG. 4 is an assembled view of FIG. 1, showing the actuation device in an open position;

FIG. 5 is similar to FIG. 4, but showing the actuation device in a closed position;

FIG. 6A is an enlarged, schematic cross-sectional view of a cam and a spring member of the actuation device corresponding to line VIA-VIA of FIG. 4, and showing the cam engaging with the spring member at the open position;

FIG. 6B is similar to FIG. 6A, but showing the cam engaging with the spring member at a position midway between the open position and the closed position;

FIG. 6C is similar to FIG. 6C, but showing the cam engaging with the spring member at the closed position; and

FIG. 7 is an isometric view of a conventional electrical connector.

### DETAILED DESCRIPTION OF THE PREFERRED EMBODIMENT OF THE INVENTION

Reference will now be made to the drawings to describe the present invention in detail.

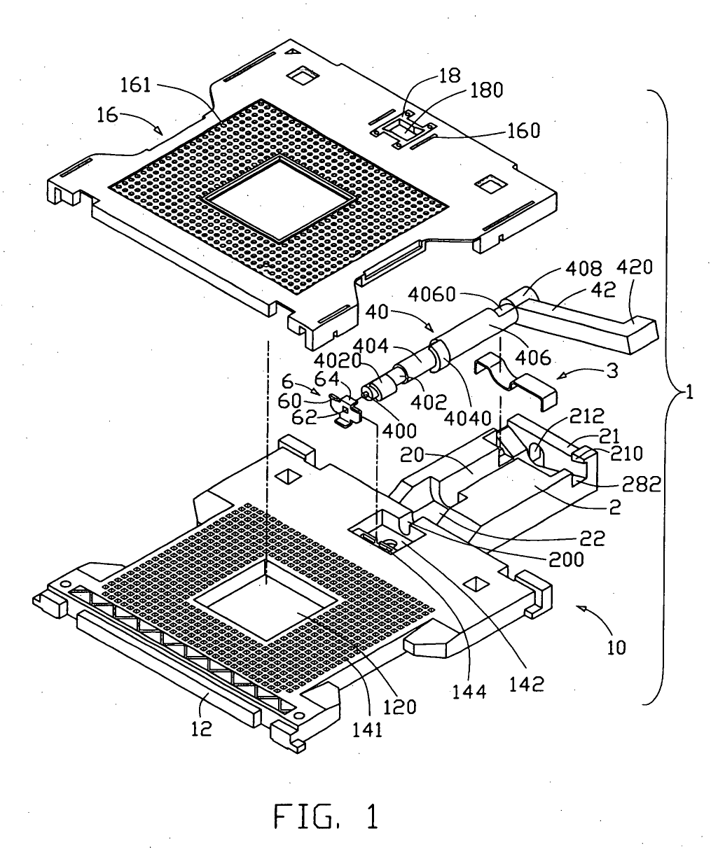

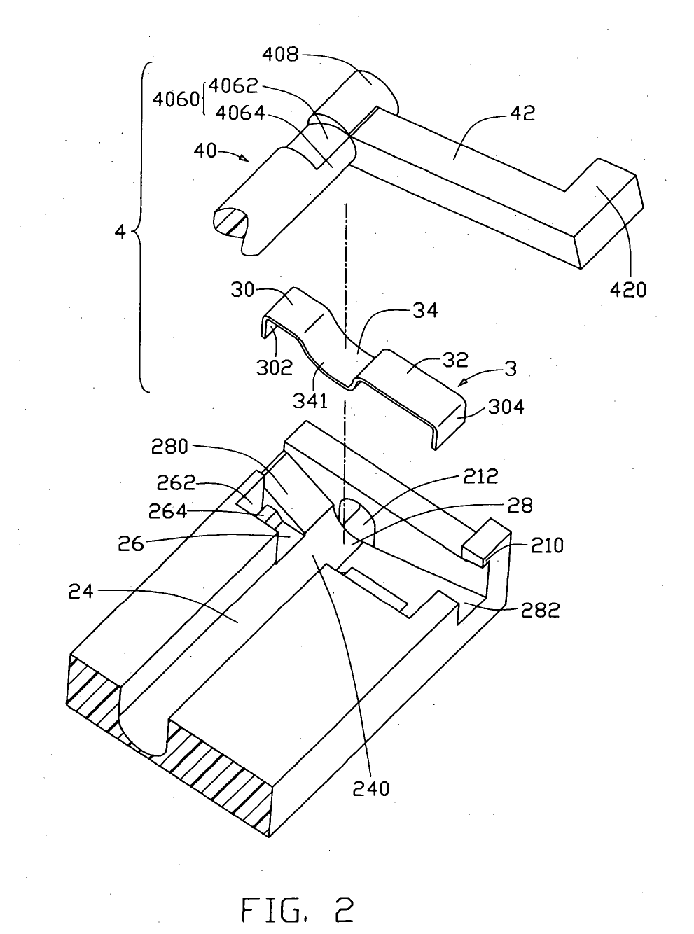

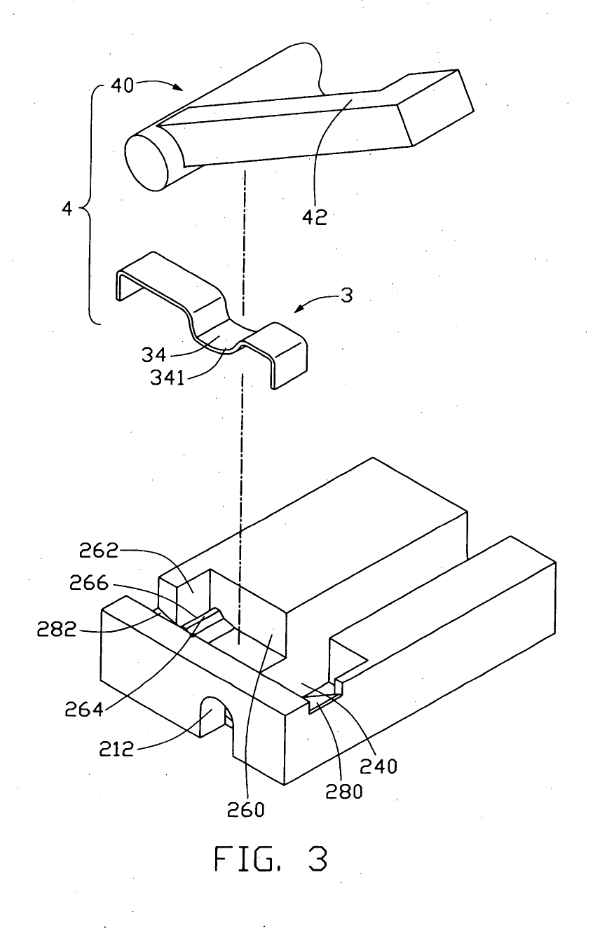

Referring to FIGS. 1, 2 and 3, an electrical connector 1 in accordance with the preferred embodiment of the present invention is for electrically connecting a central processing unit (CPU) (not shown) with a printed circuit board (PCB) (not shown). The connector 1 comprises a base 10 soldered to and electrically connected with the PCB, a cover 16 slidably mounted on the base 10 between opposite open and closed positions and having the CPU attached thereon, and an actuation device 4 assembled between the cover 16 and the base 10 for actuating the cover 16 to slide along the base 10.

The base 10 comprises a main body 12, and a head portion 2 extending from one end of the main body 12. A rectangular opening 120 is defined in a middle of the main body 12. A plurality of receiving passageways 141 is defined in the main body 12, the passageways 141 being arranged in a rectangular array around the opening 120. Each passageway 141 receives an electrical terminal (not shown) therein. The cover 16 has a plurality of through holes 161 arranged in a rectangular array, corresponding to the receiving passageways 141. Each through hole 161 receives a respective lead of the CPU therein.

The main body 12 defines a first receiving space 142 in an end thereof nearest the head portion 2. A clipping slot 144 is defined in the main body 12 in communication with the first receiving space 142, the clipping slot 144 being located between the first receiving space 142 and the opening 120. The clipping slot 144 receives a clip 6 therein. The clip 6 defines a first positioning hole 62 in a middle thereof. A pair of spaced first hooks 60 is bent rearward from a top of the clip 6. A second hook 64 is bent forward from a middle of the top of the clip 6. A third hook 64 is bent rearward from a bottom of the clip 6. The first hooks 60 and the third hook 64 are used to lock the clip 6 in the clipping slot 144. A cutout 200 is defined in the main body 12 between the first receiving space 142 and a front extremity of the main body 12. The cover 16 has a generally H-shaped metal frame 18 embedded in a front end thereof, corresponding to the first receiving space 142. The cover 16 defines a pair of parallel positioning slots 160 at opposite sides of the metal frame 18 respectively. The metal frame 18 has a receiving hole 180 defined therein.

The head portion 2 defines a second receiving space 20 therein, in communication with the cutout 200 of the main body 12. The head portion 2 forms a baffle 21 at a distal end thereof. The second receiving space 20 comprises a recess 22 in communication with the cutout 200, and a receiving slot 24 forward of and in communication with the recess 22. In addition, the second receiving space 20 is bounded by a first receiving portion 26 that is adjacent the receiving slot 24, and a second receiving portion 28 that is adjacent the first receiving portion 26. The first receiving portion 26 comprises a pair of opposite first walls 262, a pair of coplanar second walls 260 perpendicular to and adjoining respective first walls 262, a pair of blocks 264 adjacent insides of the first walls 262 respectively, a pair of grooves 266 defined between the first walls 262 and the corresponding blocks 264 respectively, and a recessed portion 240 between the blocks 264 and being in alignment with the receiving slot 24. The second receiving portion 28 comprises a slanted first positioning wall 280, and an opposite slanted second positioning wall 282. The baffle 21 forms a retaining block 210 on a free end thereof. A second positioning hole 212 is defined in the baffle 21, in alignment with the receiving slot 24.

The actuation device 4 comprises a cam pole 40, an operation lever 42 extending substantially perpendicularly from one end of the cam pole 40, and a guiding spring member 3 assembled with the cam pole 40. The spring member 3 comprises a curved, central mating portion 34, a first arm 30 extending from one end of the mating portion 34, a second arm 32 extending from an opposite end of the mating portion 34, a first ear 302 depending from a distal end of the first arm 30, and a second ear 304 depending from a distal end of the second arm 32. The mating portion 34 is concave, and comprises a bottom surface 341. The operation lever 42 defines a handle portion 420 at a free end thereof to facilitate manual handling by a user. The cam pole 40 comprises, in sequence, a first positioning column 400, a first portion 402, a second portion 404, a third portion 406 and a second positioning column 408. A diameter of the second portion 404 is greater than that of the first portion 402. A diameter of the third portion 406 is greater than that of the second portion 404. The first portion 402 defines a generally arch-shaped first block 4020 thereon, the second portion 404 defines a generally arch-shaped second block 4040 thereon, and the third portion 406 defines a cam 4060 thereat adjoining the operation lever 42. The cam 4060 comprises a curved first surface 4062, and a curved second surface 4064 opposite to the first surface 4062. A distance between any point on the first surface 4062 and a central axis of rotation of the cam pole 40 is less than that between any point on the second surface 4064 and said central axis.

Referring to FIGS. 1, 2, 3 and 4, in assembly of the connector 1, the spring member 3 is put into the first receiving portion 26 of the head portion 2. The mating portion 34 is received in the recessed portion 240, and a space is defined therebetween. The first and second ears 302, 304 are received in the corresponding grooves 266. The first positioning column 400 of the cam pole 40 is received in the first positioning hole 62 of the clip 6. The second hook 64 of the clip 6 engages on the first portion 402 of the cam pole 40. The first block 4020 of the first portion 402 is partly received in the first receiving space 142 of the main body 12. The second block 4040 of the second portion 404 is received in the recess 22. The cam 4060 of the third portion 406 engages with the mating portion 34 of the spring member 3, with the first surface 4062 contacting the bottom surface 341. The second positioning column 408 is received in the second positioning hole 212 of the baffle 21. Then the cover 16 is attached on the main body 12, with the first block 4020 partly received in the receiving hole 180 of the metal frame 18.

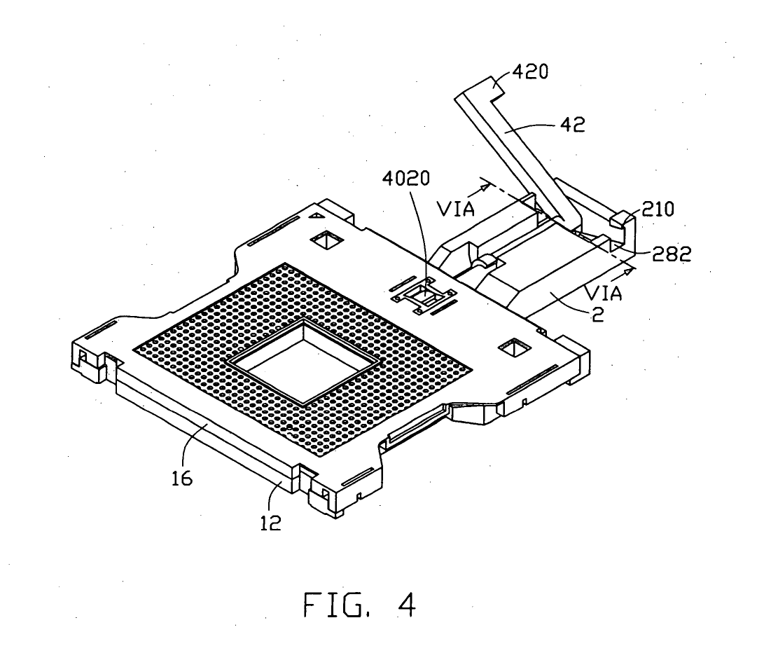

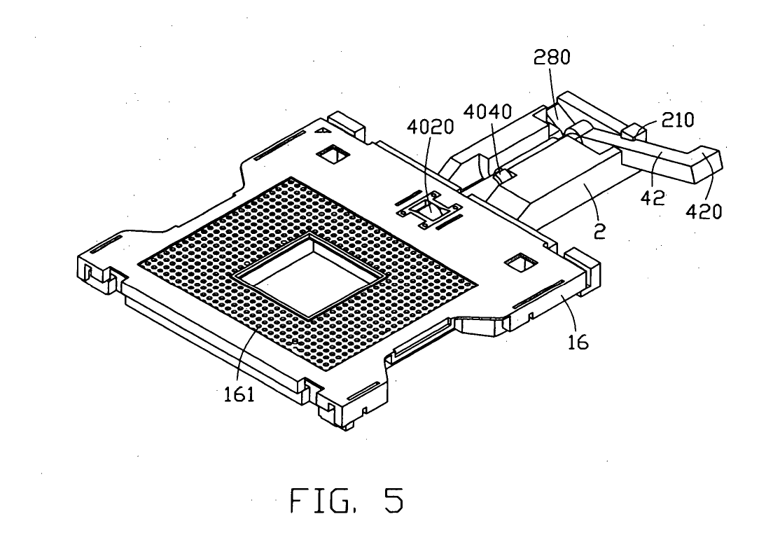

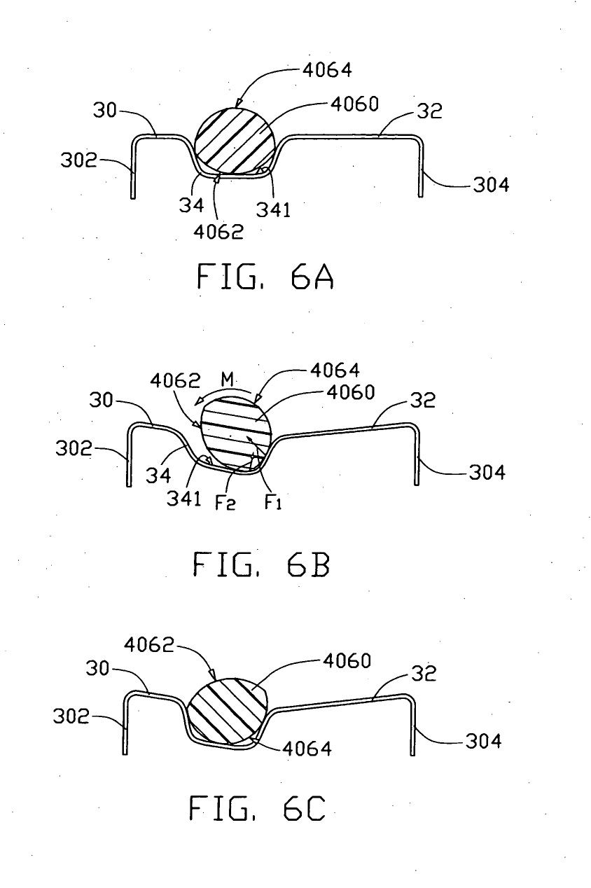

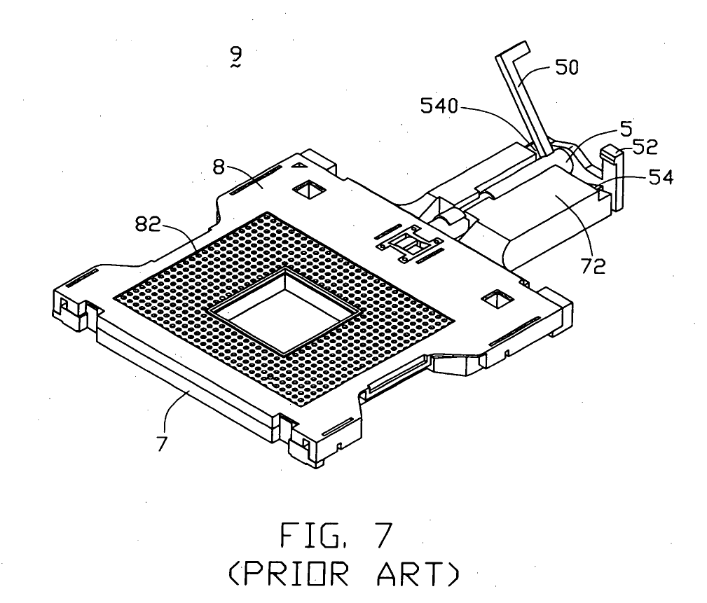

Referring to FIGS. 4 and 5, in use, the operation lever 42 of the actuation device 4 is set against the first positioning wall 280. In this state, the connector 1 is defined to be in an open position. A position of the cam 4060 in engagement with the spring member 3 at the open position is shown in FIG. 6A. Then the CPU is attached to the connector 1. The leads of the CPU extend through the corresponding through holes 161 of the cover 16 and are received in the corresponding passageways 141 of the base 10. The leads of the CPU do not contact the corresponding electrical terminals. That is, the CPU is attached on the connector 1 with zero insertion force. Then, the operation lever 42 is rotated toward the second positioning wall 282, and the first block 4020 of the cam pole 40 drives the cover 16 to slide along the main body 12. When the operation lever 42 reaches the second positioning wall 282, the handle portion 420 of the operation lever 42 is locked under the retaining block 210. In this state, the actuation device 4 has pushed the leads of the CPU into mechanical and electrical engagement with the corresponding electrical terminals, and the connector 1 is defined to be in a closed position. A position of the cam 4060 in engagement with the spring member 3 at the closed position is shown in FIG. 6C.

Prior to attachment of the CPU onto the connector 1, the operation lever 42 may inadvertently be positioned midway between the first positioning wall 280 and the second positioning wall 282. A position of the cam 4060 in engagement with the spring member 3 in such situation is represented in FIG. 6B. In this position, the cam 4060 presses the mating portion 34 of the spring member 3, the spring member 3 is elastically deformed, and the mating portion 34 produces counterforces F1, F2 on the cam 4060. Because the distance between any point on the first surface 4062 and the central axis of rotation of the cam pole 40 is less than that between any point on the second surface 4064 and said central axis, the counterforces F1, F2 cooperate to produce an counterclockwise moment M operating on the cam 4060. The cam is driven to rotate counterclockwise (as viewed in FIG. 6B), and the operation lever 42 reverts to the open position.

The connector 1 of the present invention features the operation lever 42 automatically re-positioning itself to the open position from said midway position. This ensures that the CPU is attached on the connector 1 in the open position. The leads of the CPU are prevented from being accidentally damaged, and unimpaired electrical engagement between the leads of the CPU and the corresponding electrical terminals is ensured.

While the preferred embodiment in accordance with the present invention has been shown and described, equivalent modifications and changes known to persons skilled in the art according to the spirit of the present invention are considered within the scope of the present invention as defined in the appended claims.

1. An electrical connector for electrically connecting an electronic package to a circuit substrate, the electrical connector comprising:
an insulative base having a plurality of receiving passageways defined therein;
a plurality of electrical terminals respectively received in the receiving passageways;
a cover slidably engaged on the base, the cover having a plurality of through holes defined therethrough for receiving leads of the electronic package; and
an actuation device assembled between the base and the cover for actuating the cover to slide along the base, the actuation device comprising a cam pole, and an operation lever extending substantially perpendicularly from one end of the cam pole;
wherein the actuation device further comprises a spring member, and the cam pole comprises a cam engaging with the spring member.

2. The electrical connector as claimed in claim 1, wherein the spring member comprises a mating portion, and the cam comprises a first surface engaging with the mating portion and a second surface opposite to the first surface.

3. The electrical connector as claimed in claim 2, wherein a distance between any point on the first surface and a central axis of rotation of the cam pole is less than that between any point on the second surface and said central axis.

4. The electrical connector as claimed in claim 3, wherein the base comprises a main body, and a head portion extending from one end of the main body, and the main body defines a first receiving space in an end thereof nearest the head portion.

5. The electrical connector as claimed in claim 4, wherein the cam pole comprises, in sequence, a first positioning column, a first portion, a second portion, a third portion and a second positioning column.

6. The electrical connector as claimed in claim 5, wherein the first portion defines a generally arch-shaped first block thereon, the second portion defines a generally arch-shaped second block thereon, and the third portion defines a cam thereat adjoining the operation lever.

7. The electrical connector as claimed in claim 6, wherein the first block is partly received in the first receiving space of the base.

8. The electrical connector as claimed in claim 4, wherein a clipping slot is defined in the base in communication with the first receiving space.

9. The electrical connector as claimed in claim 8, wherein the clipping slot receives a clip therein.

10. The electrical connector as claimed in claim 4, wherein the head portion defines a second receiving space therein, and the second receiving space is bounded, in sequence, by a recess, a receiving slot, a first receiving portion receiving the spring member therein, and a second receiving portion receiving the operation lever therein.

11. The electrical connector as claimed in claim 10, wherein the first receiving portion adjoins the second receiving portion, and the second receiving portion comprises two opposite slantwise surfaces.

12. The electrical connector as claimed in claim 10, wherein the first receiving portion comprises a recessed portion being in alignment with the receiving slot.

13. The electrical connector as claimed in claim 12, wherein the mating portion of the spring member is received in the recessed portion, and a space is defined therebetween.

14. The electrical connector as claimed in claim 10, wherein the first receiving portion comprises a pair of opposite first walls, a pair of coplanar second walls perpendicular to and adjoining respective first walls, a pair of blocks adjacent insiders of the first walls respectively, and a pair of grooves defined between the first walls and the corresponding blocks respectively.

15. An actuation device used for an electrical connector, the actuation device comprising:
a cam pole; and
an operation lever extending substantially perpendicularly from one end of the cam pole;
wherein the actuation device further comprise a spring member, and the cam pole comprises a cam engaging with the spring member to automatically urge the actuation device to a predetermined open position when the actuation device is released from a closed position.

16. The actuation device as claimed in claim 15, wherein the spring member comprises a mating portion, and the cam comprises a first surface engaging with the mating portion and a second surface opposite to the mating portion.

17. The actuation device as claimed in claim 16, wherein a distance between any point on the first surface and a central axis of rotation of the cam pole is less than that between any point on the second surface and said central axis.

18. An electrical connector comprising:
an insulative base with a plurality of contacts therein;
a cover mounted upon the base and movable relative to the base between opposite open and closed positions along a direction;
an actuation device mounted to at least one of said base and said cover, and operably moving said cover between said open and closed positions, and
a guiding member mounted to at least one of said base and said cover, and engageable with the actuation device so as to guidably urge said actuation device to be in a stable correct location when said cover is right about to be moved to either said open position or said closed position, thus assuring said cover is correctly located in either said open position or said closed position.

19. The connector as claimed in claim 18, wherein said actuation device defines a cam pivotal about an axis, and said cam is engaged with the guiding member for urging the actuation device to be in the stable correct location.

20. The connector as claimed in claim 19, wherein said axis extends along said direction.
